(19) United States
(12) Patent Application Publication
(10) Pub. No.: US 2011/0252153 A1
(43) Pub. Date: Oct. 13, 2011

(54) SECURELY PROVIDING SESSION KEY INFORMATION FOR USER CONSENT TO REMOTE MANAGEMENT OF A COMPUTER DEVICE

(76) Inventor: Zvi Vlodavsky, Mevaseret-Zion (IL)

(21) Appl. No.: 12/757,862

(22) Filed: Apr. 9, 2010

(51) Int. Cl. G06F 15/16; G06F 3/01

(52) U.S. Cl. 709/229; 715/740

(57) ABSTRACT

Embodiments of the invention are generally directed to systems, methods, and apparatuses for providing information used in verifying user consent to a remote management session. In some embodiments, a session key is provided by a management engine of a computer device in response to an indication that a session is needed to remotely mange operations of the computer device. In some embodiments, information based on the session key is displayed in a secure sprite, where the integrity of information is protected at least in part by the isolation of the management engine from other resources of the computer device.

### BACKGROUND

1. Field of the Invention

Embodiments of the invention generally relate to the field of computer management and, more particularly, to systems, methods and apparatuses for implementing a remote management session.

2. Background Art

Remote management technologies allow a session to be established whereby a network administrator or other manager can direct operations on a remote computer device. Such operations may include, but are not limited to, the diagnosing and/or fixing of a problem in the remote computer device. For example, a keyboard, video, mouse (KVM) session may be established in which the capability to view a computer's display, and to control its keyboard and mouse, is redirected over a network to a remote administrator.

Remote performance of sensitive operations on a computer device often requires the local user of the computer device to “opt-in”—i.e. to provide consent to the operation. Some countries and organizations require such user consent by law. The increasing diversity and sophistication of network security risks (e.g. spoofing, keyloggers and other malware) pose a growing threat to how users are to communicate such consent. Moreover, it is problematic to obtain user consent in circumstances where the user has no conventional method to do so. Such circumstances may include, for example, inoperability of an operating system (OS) of the computer device which provides for interaction with a user. For example, a computer may have an OS which is malfunctioning (e.g. in a “blue-screen” state) or the computer may remain in some pre (or post) OS state—e.g. a BIOS initialization state, reboot state, and the like.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating select elements of a system according to an embodiment to communicate user consent information.

FIG. 2 is a block diagram illustrating select elements of a management engine to provide sprite graphics information according to an embodiment.

FIG. 3 is a block diagram illustrating select elements of a computer device according to an embodiment to display user consent information.

FIG. 4 is a block diagram illustrating select elements of a computer device according to an embodiment to display user consent information.

FIG. 5 is a flow diagram illustrating select elements of an algorithm for providing session key information according to an embodiment.

FIG. 6 is a block diagram illustrating select elements of a display to present user consent information in a secure sprite according to an embodiment.

### DETAILED DESCRIPTION

Embodiments described herein provide various techniques to obtain user consent for remote management operations, securely and without depending on the computer's OS (and/or BIOS). An example of such remote management operations is opening a remote management (e.g. KVM redirection over IP) session, where an administrator can diagnose and fix a problem by viewing the user's display and controlling his keyboard and mouse. The need for user consent may be relevant for remote management operations such as power operations, IDE redirection, text redirection, etc. To provide information associated with obtaining user consent to a remote management operation—referred to herein as “user consent information”—embodiments utilize a management engine (ME) to implement a secure output capability. Such an ME may be according to the vPro™ technology of Intel® Corporation of Santa Clara, Calif. For example, such an ME may implement some or all features of the Intel® Active Management Technology (AMT).

Once a remote administrator attempts a sensitive operation on a user's computer, a ME of the computer may generate a session random key and securely display it—or information based thereon—to the user using the secure-output sprite overlay. The graphical sprite may be controlled by the ME—e.g. utilizing a dedicated hardware connection to the computer's graphic adapter. Therefore, the graphical sprite is always available, regardless of the OS state, and software executing on the OS cannot capture it. The user may be instructed in the sprite message to provide session key information to an administrator, if the user consents to remote management. This communication of session key information may be done in a phone conversation, email, instant messaging or other exchange between the user and the administrator. The administrator may then enter this session key in his console, which sends it to the ME. The ME may compare the key that it has received from the administrator to the random session key that it has generated. If the two match, the remote management session may start.

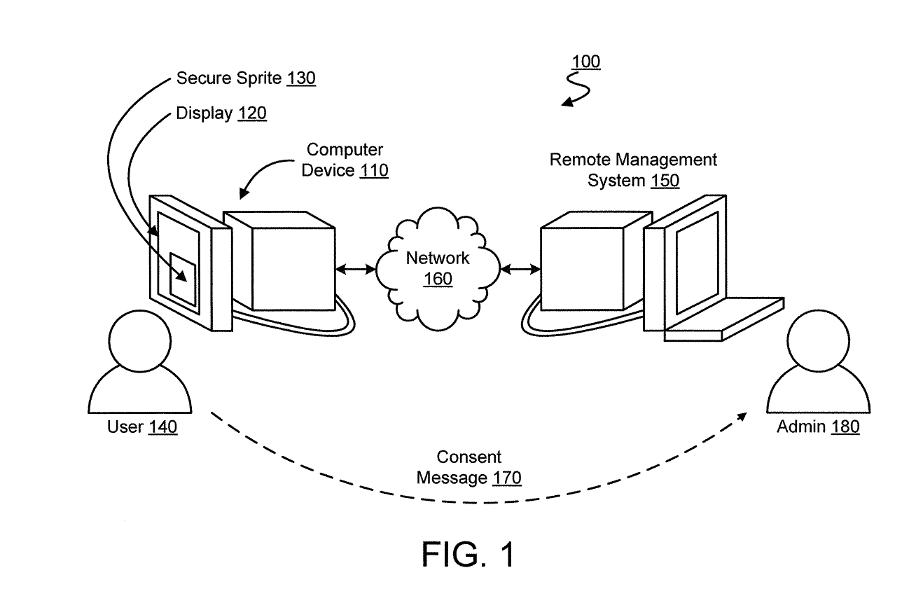

FIG. 1 illustrates select elements of a system 100 to provide, according to an embodiment, information for establishing a remote management session. System 100 may include a computer device 110 in communication with a remote management system 150—e.g. via a network 160. Network 160 may include any of a variety of combinations of one or more public and/or private, wired and/or wireless networks. For example, network 160 may include one or more of a local area network (LAN), a virtual private network (VPN), a metropolitan area network (MAN), a wide area network (WAN), an internet, and the like.

Remote management system 150 may comprise one or more computing devices—e.g. including but not limited to desktop, laptop, workstation, server and/or other similar devices—capable of participating as a manager of another device to be managed during a remote management session. With respect to remote management system 150, the term “remote” is understood to refer to remoteness (e.g. in terms of networking and/or geography) with respect to the managed device in question—e.g. computer device 110.

In an embodiment, remote management system 150 may acquire—e.g. have surrendered to it—some or all control of another device's operation during a remote management session. A remote management session may allow remote management system 150 to remotely provide, for example, discovery, healing and/or protection of one or more systems of the managed device—e.g. computer device 110. By way of illustration and not limitation, remote management system 150 may remotely direct diagnosis and/or recovery actions at computer device 110—e.g. actions including, but not limited to, one or more of installing, loading and/or restarting agents, diagnostic programs, drivers, and even operating systems. Additionally or alternatively, remote management system 150 may remotely direct safeguarding functionality of critical agents from operating system (OS) failure, power loss, and/or intentional or inadvertent user removal. It is understood that, unless indicated otherwise herein, the variety of management actions which may be performed during a remote management session is not limiting on techniques discussed herein for providing session key information to be used in communicating/verifying user consent.

Computer device 110 may include any of a variety of devices—e.g. a desktop, laptop, workstation, handheld or other similar device—capable of surrendering to another device control of some or all its local operations during a remote management session. In various embodiments, computer device 110 may include any of a variety of combinations of software and/or hardware means for providing remote management information. For example, computer device 110 may include software and/or hardware means for creating, setting up and/or configuring one or more management application interfaces which provide remote management information. By way of illustration and not limitation, computer device 110 may support remote management communications using AMT.

As described further herein, hardware and/or software of computer device 110 to help implement a remote management session may be at least partially isolated or otherwise protected from operation of one or more other resources of computer device 110. For example, a management engine (not shown) of computer device 110 may include and/or interact with processing, communication and/or storage means of computer device 110 which are protected from operations of other processing, communication and/or storage means of computer device 110.

In an embodiment, information may be detected at computer device 110 which indicates a need to initiate a remote management session. Such a need may be indicated, for example, by a request submitted by input from a local user 140 of computer device 110. Alternatively or in addition, a request may be submitted by input from an administrator 180 operating remote management system 150. For example, remote management system 150 may send to computer device 110 an explicit request for a remote management session—e.g. in an out-of-band communication via network 160.

In various embodiments, an event within system 100 may automatically trigger generation of a remote management session request from within either (or both) of computer device 110 and remote management system 150. For example, a communication, detection of an operating state, an alert of a network security risk, etc. may result in information being provided to, or generated by, computer device 100 which indicates that a remote management session is to be established. By way of illustration and not limitation, a management engine of computer device 100 may receive or generate such information without user 140 (or without administrator 180) previously requesting such remote management session.

Due in part to the surrendering of at least some operational control during a remote management session and/or the increasing variety of network security risks (e.g. spoofing attacks), it is beneficial to securely communicate that a user consents to participation in a remote management session. More particularly, it is beneficial to mitigate the risk that a computer device to be remotely managed is in a compromised state when a user relies upon that computer device for some aspect of consenting to such remote management. For example, it is beneficial to communicate user consent when the OS is not operational to otherwise provide means for communicating such consent—e.g. in the case of OS hang, blue screen scenarios, BIOS or boot stages, etc.

In various embodiments, computer device 110 may provide information to be used for indicating that user 140 consents to a remote management session. For example, in response to detecting that a remote management session is to be established, a session key may be generated, or otherwise accessed, for providing a way to verify a user's communication of consent. Information based on the session key may be provided to user 140—e.g. in a display 120. Display 120 may include a graphical user interface which is provided in any of a variety of video devices—e.g. a monitor, computer screen, television or other similar device. For example, display 120 may be presented in a display screen which is integrated into computer device 110 or in a separate display device which is controlled by computer device 110.

Remote management information—such as first session key information based on the session key—may be presented in a secure sprite 130 within display 120. Display 120, and the secure sprite 130 therein, may be based at least in part on graphics information provided by computer device 110. In an embodiment, graphics information used to generate different portions of display 120 may come from different respective resources within computer device 110. For example, a first resource of computer device 110 may provide first graphics information specific to elements of secure sprite 130, whereas one or more other resources of computer device 110 may provide second graphics information which is for elements of display 120 other than secure sprite 130.

By way of illustration and not limitation, a management engine of computer device 110 may include the first resource, whereas the one or more other resources—e.g. one or more of an OS, and application running thereon, a controller, a memory region, a bus, etc.—may be external to the management engine. Isolation of various resources of computer device 110 from the management engine may protect the integrity of information displayed in secure sprite 130.

User 140 may avail of information displayed in secure sprite 130 to communicate consent to establishing a remote management session. For example, secure sprite 130 may present first session key information to user 140 which is based on a session key provided in computer device 110. A consent message 170 sent from user 140 may include second session key information which is based on the displayed first session key information of secure sprite 130.

Consent message 170 may be provided to administrator 180—e.g. by telephone, email, instant messaging, voice over IP (VOIP) or any other of a variety of communication means. In an embodiment, consent message 170 may be exchanged along a path which is independent of one or more of computer device 110, network 160 and remote management system 150. In an alternate embodiment, consent message 170 may be provided to remote management system 150 independent of administrator 180. In still another embodiment consent message 170 may be provided to some other agent (not shown) which is to verify, on behalf of remote management system 150 and/or administrator 180, that user 140 consents to establishing a remote management session.

Second session key information in consent message 170 may be used to verify whether a remote management session to be established has been properly consented to by user 140. For example, in response to consent message 170, administrator 180 may input to remote management system 150 data which is based on the second session key information. Remote management system 150 may use this data to participate in one or more exchanges with computer device 110 for establishing the remote management session. Such exchanges may include computer device 110 receiving third session key information based on the second key information of consent message 170. Computer device 110 may have access to an original session key upon which the first key information of secure sprite 130 was based. Computer device 110 may evaluate the received third session key information based on the original session key to verify whether the remote management system 150 is attempting to establish a remote management session which is properly consented to.

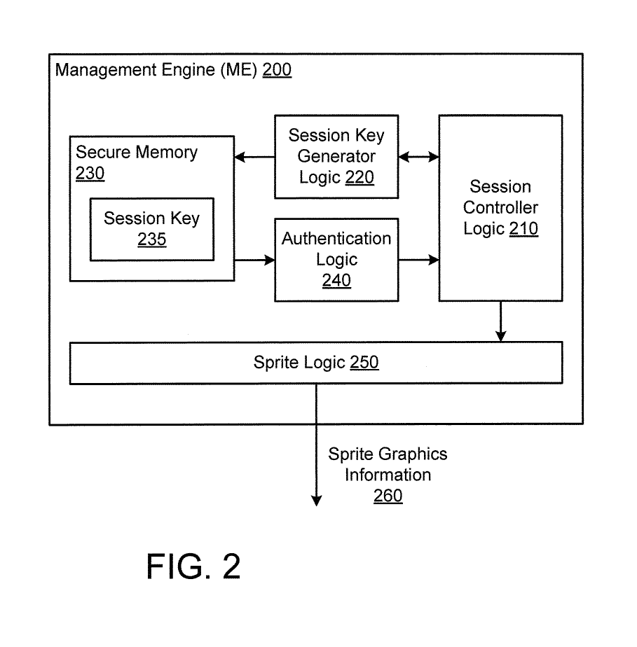

FIG. 2 illustrates select elements of a management engine 200 to provide session key information according to an embodiment. Management engine 200 may implement some or all of the features described herein with respect to the management engine of computer device 100, for example.

In an embodiment, management engine 200 may include one or more of a session controller 210, a session key generator 220, a secure memory 230, authentication logic 240 and sprite logic 250. The various elements of management engine 200 may each be implemented, independently or in combination, by one or more hardware and/or software means. For example, functions may be performed within management engine 200 using various types of circuitry including, but not limited to, one or more of a processor, a controller, a state machine, a field-programmable gate array (FPGA), a programmable read-only memory (PROM), an application-specific integrated circuit (ASIC), and the like. Alternatively or in addition, various functions of management engine 200 may performed using software instructions which are executed by such circuitry. In an embodiment, some or all elements of management engine 200 may reside on a dedicated chipset of a computer device, where the chipset is protected from certain operations of one or more other integrated circuits—e.g. one or more of a processor, controller, memory, etc.—of the computer device.

Management engine 200 may provide information to be used for verifying that a user consents to a remote management session. For example, session controller logic 210 may communicate information to control whether or how a remote management session is to be established with a remote management system. In an embodiment, session controller logic 210 may communicate such information in response to detecting a condition indicating a need to establish a remote management session. For example, session controller logic 210 may detect an explicit request for a remote management session—e.g. from a user of the computer device to be managed or an operator of a system to provide the remote management. Alternatively or in addition, session controller logic 210 may detect some other communication exchange, or network security risk or operating state of a computer platform which is indicative of a need for a remote management session.

Where a remote management session is indicated, session controller logic 210 may send a request for a session key—e.g. to session key generator logic 220. Session key generator logic 220 may generate or otherwise access a session key 235 which is to be used for communicating that a user consents to the remote management session which is indicated. For example, session key generator logic 220 may randomly generate or otherwise calculate a value for the session key 235.

Session key 235, or information for determining the generated session key 235, may be stored by session key generator logic 220—e.g. in a secure memory 230. In an embodiment, secure memory 230 may be inaccessible to one or more resources—e.g. a general purpose OS (not shown)—of the computer platform in which management engine 200 operates. It is understood that in various embodiments, secure memory 230 may be external to management engine 200—e.g. in a partition of a computer memory which is inaccessible to the computer device's general purpose OS.

The session key 235, or information based on the session key, may be directly or indirectly provided to sprite logic 250—e.g. via session controller logic 210. Sprite logic 250 may thereby generate sprite graphics information 260 for use in displaying a secure sprite. For example, sprite logic 250 may output sprite graphics information 260 for a display engine (not shown) to display a secure sprite including first session key information based on the generated session key.

Subsequent to providing sprite graphics information 260, management engine 200 may receive—e.g. in an out-of-band communication—session key information from a remote management system requesting control of a computer device—e.g. a computer including ME 200. Session controller logic 210 may direct the authenticator logic 240 to determine the session key 235 for evaluating the received session key information from the remote management system. Where a comparison of the session key 235 and the received session key information indicates proper consent by a user, session controller logic 210 may establish a remote management session.

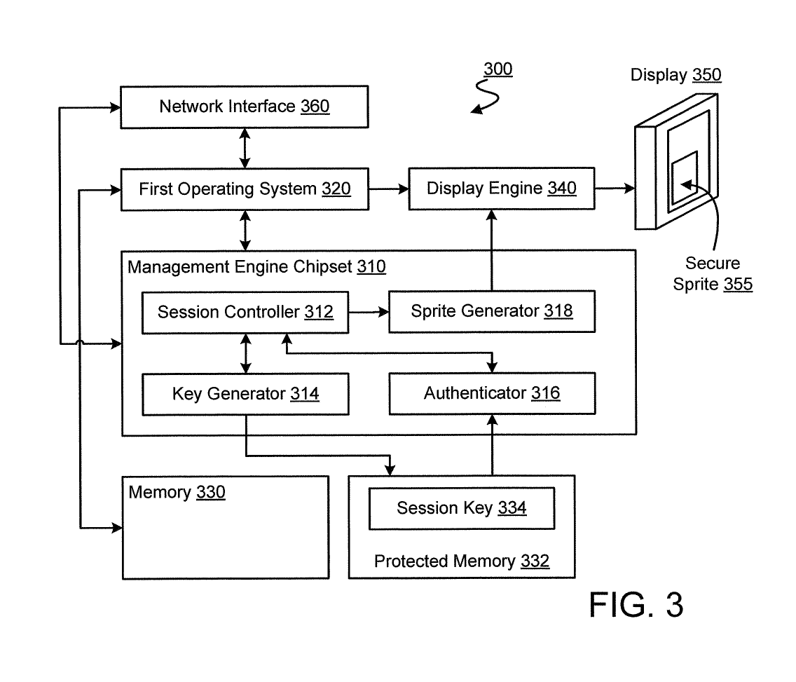

FIG. 3 shows a block diagram illustrating select elements of a computer device 300 according to an embodiment. Computer device 300 may include some or all of the features of computer device 100, for example. In an embodiment, computer device 300 may have a management engine chipset 310 including dedicated hardware to implement some or all features of a management engine—e.g. one or more features of management engine 200. Management engine chipset 310 may include one or more integrated circuit (IC) chips which are separate from—e.g. cannot be accessed at least directly by—some other IC chip of computer device 300.

By way of illustration and not limitation, computer device 300 may include a first operating system 320 which is executed with a processing unit (not shown) that is external to management engine chipset 310. The processing unit may have limited or no ability to access management engine chipset 310. For example, a processing unit executing first operating system 320 may be unable to initiate access to management engine chipset 310 and/or to directly access management engine chipset 310, although management engine chipset 310 may have an ability to initiate communication with, monitor and/or control the processing unit executing first operating system 320.

In an embodiment, management engine chipset 310 may include session controller 312, key generator 314, authenticator 316 and sprite generator 318—e.g. to provide, respectively, the functionalities of session controller logic 210, session key generator logic 220, authenticator logic 240 and sprite logic 250. Session controller 312 may determine that some communication, operating state of computer device 300, network security risk, etc. indicates a need for a remote management session. Based at least in part on the indicated need for a remote management session, session controller 312 may signal key generator 314 to access, determine or otherwise generate a session key 334 which may be used for verifying that a user consents to the indicated remote management session.

Session key 334, or information based thereon, may be stored—e.g. in a protected memory 332. Protected memory 332 may be separate from other memory 330 of computer device 300 which is accessible to first operating system 320. Session key 334, or information based thereon, may also be provided directly or indirectly to sprite generator 318—e.g. via session controller 312. The information provided to sprite generator 318 may be used to generate sprite graphics information—i.e. information which may be used to determine the displaying of a sprite.

Sprite graphics information from sprite generator 318 may be provided to a display engine 340 of computer device 300. In an embodiment, the display engine 340 may reside within a management engine such as management engine chipset 310. Based on the received sprite graphics information, display engine 340 may determine the displaying of a secure sprite 355 in display 350. By way of illustration and not limitation, display engine 340 may receive graphics output from other resources of computer device 300—e.g. from first operating system 320—which are to determine the displaying of user interface elements in display 350 other than the secure sprite 355. In an embodiment, the sprite graphics information provided to display engine 340 by sprite generator 318 may be inaccessible to the first operating system 320 and/or any software executing thereon. In an embodiment, only sprite information from sprite generator 318 is to be provided in display 350.

Display engine 340 may process the graphics output from first operating system 320 and the sprite graphics information from sprite generator 318 to determine how the secure sprite 355 is to be displayed with respect to user interface elements which first operating system 320 intends to have displayed. In an embodiment, processing sprite graphics information may include determining how secure sprite 355 is to overlap other user interface elements in display 350. Alternatively or in addition, processing sprite graphics information may include determining how to represent that user interface elements in display 350 other than secure sprite 355 are locked—i.e. disabled from user interaction—during a displaying of the secure sprite.

Management engine chipset 310 may determine that a management system remote from computer device 300 is attempting to establish a remote management session to manage computer device 300. For example, session controller 312 may determine that a message from a remote management system—e.g. exchanged via a network interface 360 of computer device 300—includes session key information which is offered as indicating a user's consent to a remote management session. In an embodiment, such message exchanges between management engine chipset 310 and the remote management system may be via conduct out-of-band communications which are not accessible to first operating system 320.

In response to communications from the remote management system, authenticator 316 may access the protected memory 332 to read, calculate or otherwise determine the session key 334. The session key information in the message received from the remote management system may be evaluated based on the session key to determine whether it indicates user consent which is based on the secure sprite 355.

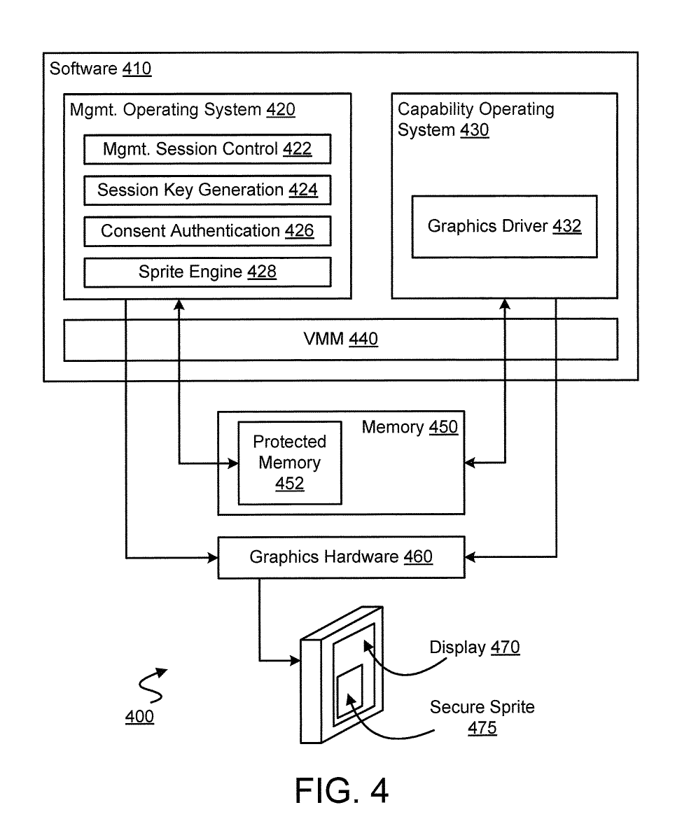

FIG. 4 illustrates select elements of a computer device 400 according to an embodiment. In an embodiment, computer device 400 may include some or all of the features of computer device 100, for example. Computer device 400 may include software 410 having one or more processes to help implement a remote management session—e.g. where the processes have some isolation to protect them from operations of other hardware or software of computer device 400. Although discussed herein in terms of virtualization, it is understood that the isolation of such processes may be implemented, for example, by separate process cores, process threads, etc.

Various mechanisms exist for enabling virtualization on a platform. Virtualization Technology (VT) may be implemented in a variety of ways on platforms, for instance, available from Intel Corporation. VT enables hardware based virtualization of operating systems. Computer device 400 may be implemented such that the architecture of software 410 is split into two or more virtualized operating systems—e.g. a management operating system (MOS) 420 and a capability operating system (COS) 430—running on top of a virtual machine monitor (VMM) 440. COS 430 may implement a user environment, and MOS 420 may provide management services including, for example, controlling participation in a remote management session. The remote management session may include, for example, MOS 420 and/or VMM 440 implementing various diagnosis, recovery or other management actions for computer device 400—e.g. under the direction of a remote management system.

In an embodiment, management OS 420 may provide some or all of the features of management engine 200. For example, management OS 420 may execute one or more of a management session control process 422, a session key generation process 424, consent authentication process 426 and sprite engine 428—e.g. to provide, respectively, the functionalities of session controller logic 210, session key generator logic 220, authenticator logic 240 and sprite logic 250.

Session control process 422 may identify a need for a remote management session in which one or more operations of computer device 400 are managed by a remote management system. In response to the identifying the need for a remote management session, session key generation process 424 may provide to sprite engine 428 information representing a session key to be used in verifying that a user of computer device 400 consents to the remote management session. The generated session key, or data for determining the session key, may be stored in a protected memory 452—e.g. a component or partition of computer memory 450 to which COS 430 does not have access privileges.

With information provided by session key generation process 424, sprite engine 428 may determine sprite graphics information for a secure sprite 475 which, when included in a display 470, may present session key information to a viewer for use in consenting to the remote management session.

In an embodiment, sprite graphics information from the sprite engine 428 may be provided to graphics hardware 460 of computer device 400. Graphics hardware 460 may also receive other graphics information—e.g. from a graphics driver 432 of COS 430—which corresponds to features of display 470 other than secure sprite 475. In an embodiment, graphics hardware 460 may display secure sprite 475 alone, without also displaying any information from COS 430. The sprite graphics information provided to graphics hardware 460 from sprite engine 428 may be inaccessible to COS 430.

With graphics information from sprite engine 428, graphics hardware 460 may determine whether and/or how the secure sprite 475 is to be displayed—e.g. in relation to any other elements for display 470. In an alternate embodiment, graphics information from graphics driver 432 may be provided to sprite engine 428, which, before providing final graphics information to graphics hardware 460, resolves the displaying of secure sprite 475 in relation to other elements of display 470.

At some time after displaying secure sprite 475, consent authentication process 426 may evaluate information associated with a request to establish a remote management session. For example, consent authentication process 426 may receive session key information sent to computer device 400 from a remote management system (not shown). Consent authentication process 426 may access protected memory 452 to determine the session key generated by session key generator process 424. Consent authentication process 426 may evaluate the received session key information based on the session key, to determine whether consent to the remote management session has been properly based on the session key. Where proper consent has been determined, management session controller process 420 may establish the requested remote management session.

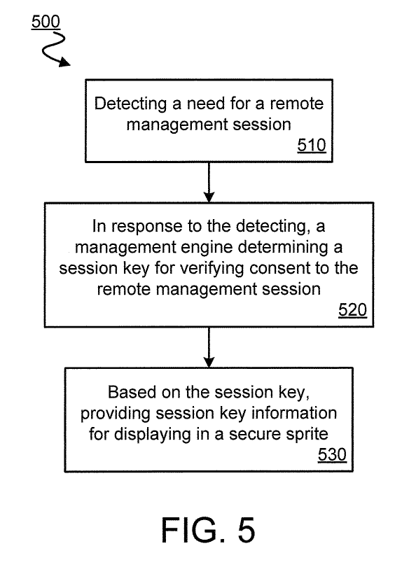

FIG. 5 illustrates select elements of an algorithm 500 to provide, according to an embodiment, session key information for consenting to a remote management session. Algorithm 500 may be performed by computer device 110, for example. Algorithm 500 may include detecting, at 510, a need for a remote management session. Such detecting may be performed by session controller logic 210, for example. In response to the detecting, a management engine may determine, at 520, a session key to be used in verifying consent to the remote management session. The management engine may provide for remote management of a computer device in which the management engine resides. In an embodiment, the management engine is isolated from access by certain resources of the computer device, such as a processor, operating system and/or virtual machine, which provide a user environment. Based on the session key, session key information may be provided, at 530, for displaying in a secure sprite. The session key information and/or the secure sprite may be inaccessible to one or more resources from which the manageability engine is isolated.

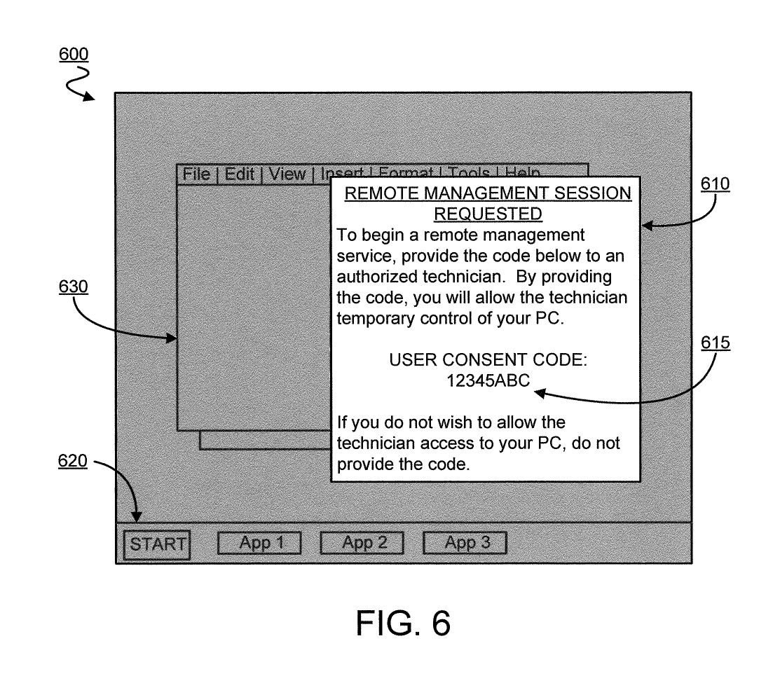

FIG. 6 illustrates select elements of a display 600 to provide remote management information according to an embodiment. Display 600 may include some or all of the information provided in display 120, for example. Display 600 may include a secure sprite 610 which includes session key information—e.g. a user consent code 615—for use in verifying that a user consents to a remote management session. Secure sprite 610 may be understood to be “secure” at least insofar as the integrity of some or all information therein is independent of whether certain resources of a computer device are in a compromised or otherwise non-operational state, where those resources provide information for the displaying of other features of display 600.

In an embodiment, display 600 may include information prompting the user to provide such session key information as an indication of such consent. For example, secure sprite 610 may instruct a user to provide a user consent code 615 to a remote management system for use in establishing a remote management session.

In an embodiment, display 600 may have one or more user interface elements other than secure sprite 610—including, but not limited to, operating system graphics 620 for interaction with functions of a computer device's operating system and application graphics 630 for interaction with functions of an application executing on the computer device. User interaction with some or all of operating system graphics 620 and/or application graphics 630 may be selectively enabled/disabled during the displaying of secure sprite 610. The particular operating system graphics 620 and application graphics 630 shown in display 600 are merely illustrative, and are not limiting on various embodiments. In another embodiment, display 600 may only include secure sprite 615—i.e. without also including any other graphical elements. In an embodiment, secure sprite 610 may be presented when no other capability OS graphical information is being provided to display 600. This may occur, for example, when the computer system controlling display 600 is in a pre-OS stage (e.g. in a BIOS screen, or during a boot stage) or in a post-OS stage (e.g. OS “blue screen” inoperability).

Techniques and architectures for communicating user consent information are described herein. In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, the present invention is not described with reference to any particular programming language. It will be appreciated that a variety of programming languages may be used to implement the teachings of the invention as described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method comprising:
detecting a need for a remote management session;
in response to the detecting, a management engine determining a session key to be used in verifying a consent to an establishing of the remote management session; and
based on the determining the session key, providing first session key information for representation in a secure sprite of a display.

2. The method of claim 1, further comprising:
receiving second session key information from a remote management system; and
comparing the received second session key information with the session key to verify the consent to the establishing of the remote management session.

3. The method of claim 1, wherein the remote management session is to manage a computer device including a first operating system, the method further comprising:
the management engine storing information based on the session key in a protected memory which is not directly accessible by the first operating system.

4. The method of claim 1, wherein the remote management session is to manage a computer device including a first operating system and a virtual machine isolated from the first operating system, the virtual machine including the management engine.

5. The method of claim 1, wherein the management engine resides on a dedicated chipset.

6. The method of claim 1, further comprising:
representing the first session key information in the secure sprite of the display.

7. The method of claim 6, wherein one or more other resources of a computer device provide graphics information for elements of the display other than the secure sprite, and wherein the one or more other resources of the computer device are external to the management engine.

8. An apparatus for providing user consent information, the apparatus comprising:
a management engine including:
a session controller to detect a need for a remote management session;
a session key generator coupled to the session controller to determine, in response to detecting the need for the remote management session, a session key to be used in verifying a consent to an establishing of the remote management session; and
a sprite engine coupled to the session key generator to provide first session key information based on the determined session key, the first session key information for representation in a secure sprite of a display.

9. The apparatus of claim 8, wherein the session controller further to receive second session key information from a remote management system, the apparatus further comprising:
an authenticator to compare the received second session key information with the session key to verify the consent to the establishing of the remote management session.

10. The apparatus of claim 8, further comprising a protected memory, wherein the display is to display graphical information provided by a first operating system, the session key generator further to store in the protected memory information based on the session key, wherein the protected memory is isolated from access by the first operating system.

11. The apparatus of claim 8, wherein the management engine resides on a dedicated chipset.

12. The apparatus of claim 8, wherein the remote management session is to manage a computer device and wherein a user of the computer device indicating consent to the remote management session does not require the user to provide input to the computer device.

13. The apparatus of claim 8, wherein one or more other resources of a computer device provide graphics information for elements of the display other than the secure sprite, and wherein the one or more other resources of the computer device are external to the management engine.

14. A computer readable storage medium having stored thereon, which when executed by one or more processing units cause the one or more processing units to perform a method comprising:
detecting a need for a remote management session;
in response to the detecting, a management engine determining a session key to be used in verifying a consent to an establishing of the remote management session; and
based on the determining the session key, providing first session key information for representation in a secure sprite of a display.

15. The computer readable storage medium of claim 14, the method further comprising:
receiving second session key information from a remote management system; and
comparing the received second session key information with the session key to verify the consent to the establishing of the remote management session.

16. The computer readable storage medium of claim 14, the method further comprising:
the management engine storing in a protected memory information based on the session key.

17. The computer readable storage medium of claim 16, wherein the remote management session is to manage a computer device including a first operating system, and wherein the protected memory is not directly accessible by the first operating system.

18. The computer readable storage medium of claim 14, wherein the management engine resides on a dedicated chipset.

19. The computer readable storage medium of claim 14, the method further comprising:
representing the first session key information in the secure sprite of the display.

20. The computer readable storage medium of claim 19, wherein one or more other resources of a computer device provide graphics information for elements of the display other than the secure sprite, and wherein the one or more other resources of the computer device are external to the management engine.
